(19) United States
(12) Patent Application Publication
(10) Pub. No.: US 2024/0388052 A1
(43) Pub. Date: Nov. 21, 2024

(54) TEMPERATURE-CONTROLLED POWER LINE DEVICE PRODUCTION METHOD THEREOF AND METHOD FOR TEMPERATURE CONTROL OF A POWER LINE

(71) Applicant: Witzenmann GmbH, Pforzheim (DE)

(72) Inventor: David EHRENBERGER, Königsbach-Stein (DE)

(73) Assignee: Witzenmann GmbH, Pforzheim (DE)

(21) Appl. No.: 18/659,078

(22) Filed: May 9, 2024

(30) Foreign Application Priority Data
May 17, 2023 (DE) 102023113116.8

(51) Int. Cl. H01R 43/28; H01R 11/12

(52) U.S. Cl. CPC H01R 43/28; H01R 11/12

(57) ABSTRACT

A temperature-controllable power line apparatus having: a tubular fluid line element made of an electrically conductive material, in particular metal, preferably copper or aluminum, including corresponding alloys; at least two openings of the fluid line element, which openings are preferably arranged at different ends of the fluid line element; and a free space inside the fluid line element, which free space provides a fluid-guiding connection between the two openings. A strand having a plurality of strand wires, preferably made of copper, is guided fluid line element; the free space extends at least in regions along the fluid line element around the strand; and the strand or the strand wires in at least one connection region is/are placed on the fluid line element, preferably pressed, or vice versa. A method for producing a temperature-controllable power line apparatus and a method for temperature-controlling a power line are further provided.

### CROSS-REFERENCE TO RELATED APPLICATIONS

This application claims priority to German Patent Application No. 10 2023 113 116.8, filed May 17, 2023, which is incorporated herein by reference as if fully set forth.

### TECHNICAL FIELD

The invention relates to a temperature-controllable power line apparatus having: a tubular fluid line element made of an electrically conductive material, in particular metal, preferably copper or aluminum, including corresponding alloys; at least two openings of the fluid line element, which openings are preferably arranged at different ends of the fluid line element; and a free space inside the fluid line element, which free space provides a fluid-guiding connection between the two openings.

The invention also relates to a method for producing a temperature-controllable power line apparatus and a method for temperature-controlling a power line.

### BACKGROUND

Electromobility is often viewed today as a measure against continuing climate change. In order to increase the acceptance of electric vehicles, it is necessary to reduce the required charging times and to increase the ranges. Manufacturers such as Phoenix Contact therefore offer direct current (DC) rapid charging systems which with a charging power of 350 kW can charge a battery in approximately five minutes for a range of 100 km.

However, higher charging currents result in higher heating and consequently a thermal loading of the material used. In order to reduce this, an increase of the conductor cross sections could be taken into consideration which, however, would involve disadvantages in terms of handling as a result of low flexibility and the higher weight of the charging cable. For this reason, in previously known systems, the DC charging plugs are cooled with a medium.

From WO 2021/259638 A1, tubular connectors between connections of battery cells which comprise an electrically conductive material are known in order to electrically contact the battery cells and which at the same time act as fluid line elements for a temperature-control fluid in order to control the temperature of the battery cells.

Furthermore, for example, Paul Druseidt Elektrotechnische Spezialfabrik GmbH & Co. KG provides water-cooled waveguide cables which are produced in a complex manner from a large number of individual components. In particular during the manufacture, a large number of manufacturing steps are required in this instance. In addition, the components used can for the most part only be produced by machining and are consequently not available in relatively large batch numbers for mass production in a cost-effective manner.

### SUMMARY

In one aspect, the object of the invention is to further improve the cooling power which can be achieved with such systems.

In one aspect, the object of the invention is to further improve the power supply which can be achieved with such systems.

A further object of the invention is to simplify the production of temperature-controllable power line apparatuses and thereby to make them more cost-effective and suitable for mass production.

This is achieved according to the invention by a temperature-controllable power line apparatus having one or more of the features disclosed herein, by a method for producing a temperature-controllable power line apparatus having one or more of the features disclosed herein, and by a method for temperature-controlling a power line using one or more of the features disclosed herein.

Advantageous further developments are defined below and in the claims.

A temperature-controllable power line apparatus according to the invention having:
a tubular fluid line element made of an electrically conductive material, in particular metal, preferably copper or aluminum, including corresponding alloys; at least two openings of the fluid line element, which openings are preferably arranged at different ends of the fluid line element; and a free space inside the fluid line element, which free space provides a fluid-guiding connection between the two openings, is characterized in that in the fluid line element a strand having a plurality of strand wires, preferably made of copper, is guided; the free space extends at least in regions along the fluid line element around the strand; and the strand or the strand wires in at least one connection region, preferably in a respective connection region, at each end of the fluid line element on which the fluid line element is/are placed, preferably pressed, or vice versa.

The term “stranded wire” is in this instance and below, as is generally conventional in electrical technology, intended to be understood to be an electrical conductor which comprises relatively thin individual wires (strand wires) and which is therefore easy to bend. Copper is primarily used as the conductor, without the invention being limited to this. The invention is also not limited with regard to the dimensions (cross sections) of the strand wires so that they can in principle also be in the form of bent or bendable (copper) rods.

The wording “or vice versa” sets out that it is in principle insignificant whether the strand is placed on the fluid line element or whether alternatively the fluid line element is placed on the strand.

The wording “around the strand” may also include the fact that the free space is located at least locally between individual wires or bundles of wires of the strand or even radially internally, that the strand is thus arranged around the free space. Ultimately, it means that the strand can be virtually “washed around” by a temperature-control fluid.

In this manner, the fluid line element and the strand act together as power conductors, which enables with the same outer diameter of the apparatus the possible (cross sectional) proportion of temperature-controllable power conductor to be significantly increased. The temperature-control fluid flows around the strand wires within the free space and at the same time also controls the temperature of the fluid line element per se, whereby an improved cooling power is achieved.

The temperature-controllable power line apparatus can be produced by means of the method according to the invention in a simple, cost-effective manner and with series production. The method for producing a temperature-controllable power line apparatus comprises the following steps, of which some may be advantageous but are nonetheless only optional:
a) producing a tubular fluid line element from an electrically conductive material, in particular metal, preferably copper or aluminum, including corresponding alloys, in particular by there initially being produced by bending or rolling sheet metal a hollow member which is then welded at the joints;
b) optionally forming at least one corrugated portion of the fluid line element, in particular by applying pressure from the outside or from the inside;
c) optionally cleaning the fluid line element;
d) optionally fitting an EMC shielding, in particular having the features according to an embodiment of the power line apparatus according to the invention described below;
e) cutting the fluid line element including the optional EMC shielding (if provided) to a desired length;
f) providing at least two openings in the fluid line element, which openings are preferably arranged at different ends of the fluid line element, extremely preferably by punching out a wall of the fluid line element;
g) introducing a strand with a plurality of strand wires, preferably made of copper, the length of which corresponds to the desired length in step e), in the fluid line element; and
h) placing the strand or the strand wires in at least one connection region on the fluid line element, preferably in a connection region at each end of the fluid line element, preferably by means of pressing, or vice versa.

A method according to the invention for temperature-controlling a power line involves:
a) providing a power line apparatus according to the invention;
b) electrically contacting the power line apparatus in the connection region, preferably in the two connection regions;
c) directing a temperature-control fluid, in particular air or a dielectric oil, through the fluid line element via the openings, that is to say, inwardly through one opening and out again through the other opening.

In the context of embodiments of the invention, it is proposed to provide an electrically conductive, in particular flexible connection (the power line apparatus mentioned) which comprises a preferably corrugated pipe (the mentioned fluid line element), which pipe surrounds conductive strand wires and through which a temperature-control fluid can additionally flow.

The corrugation, if provided, may be carried out partially, that is to say, be limited to pipe portions and may be configured to be both concentrically corrugated in an annular manner and also corrugated in a helical manner. In this instance, starting from a smooth pipe, both corrugations which increase the diameter and corrugations which decrease the diameter (which can preferably be produced by means of hydraulic or mechanical shaping) and a combination of both corrugation types are possible.

According to the invention, the pipe is produced from an electrically highly conductive material, for example, copper, extremely preferably from an aluminum or copper alloy.

The pipe may in particular have non-round cross sections, where applicable only in partial portions, in order, for example, to be able to overcome narrow locations in the structural space with regard to future use.

At the ends, the pipe is preferably used to press the strand or the individual strand wires and in this manner, without any additional component to form a (press) cable lug. The cable lug which is formed in this manner may optionally be provided with a recess (aperture) in order to produce an electrical coupling connection by means of clamping, preferably by means of screwing, which provides an adequate contact face for the transmission of the electrical current.

During or before the pressing mentioned, the pipe can be locally cut or otherwise opened in the region of the wall thereof, for example, punched, so that an opening for coupling a fluid mass flow (of the temperature-control fluid) is produced in the pipe. In combination with the use of (compressed) air as a temperature-control fluid, a simple and particularly advantageous variant is produced in this instance.

Preferably, the pipe may be configured in an identical manner at both ends, that is to say, for example, pressed and provided with an additional opening for coupling or uncoupling the temperature-control fluid.

The apparatus described above is characterized in that it can for the most part be produced in a particularly cost-effective, continuous manner.

The following method steps may follow each other in a flexible combination during the production:
pipe welding (producing the pipe by means of longitudinal seam welding), in particular with a strand already laid;
pressing the pipe and strand, preferably in specific regions;
mechanically corrugating and compressing the extended strand for flexibility;
fitting, for example, by means of extruding, an inner insulation of the pipe;
fitting an outer winding and/or braid shielding (EMC shielding);
fitting, for example, by extruding, an external insulation;
separating (cutting to length) the apparatus;
end shortening of the insulation and shielding;
optional assembly of a cable introduction element with shielding contacting, for example, for connection to a housing or the like.

The pressing may, where applicable, also be carried out after the insulation and separation as long as the required flexibility of the arrangement still permits this.

A variant of the invention has at the ends an additional element for fluid coupling which enables a temperature-control fluid supply line to be fitted in a sealing manner. In particular for liquid temperature-control fluids, this variant appears to be advantageous. In this instance, the end pressing of the pipe and strand is intended to be sealed in a fluid-tight manner, which can preferably be carried out by means of a materially engaging method, such as soldering or welding. Additionally or alternatively, a sufficiently tight connection can also be produced by means of increased pressing of appropriate material pairings for the pipe and strand. A materially engaging joining process is then omitted. Soft, electrically conductive materials, in particular pure copper, are particularly preferred in this context.

In addition, a flow element can support the sealing by means of pressing, which flow element flows under pressure into the intermediate spaces of the strand and seals it with respect to the shaped pipe element. In particular, it may be advantageous to introduce an additional soft electrically conductive material, for example, relatively soft metals or electrically conductive adhesives. A possible alternative is the introduction of an additional (copper) solder.

The additional element for fluid coupling may preferably be produced in a shaping manner, extremely preferably by means of an extrusion or by means of flow punch forming.

Furthermore, with regard to costs, flexibility and service-life, a variant of the invention described which does not have a single continuous pipe element (tubular fluid line element), but instead a plurality of assembled pipe segments is advantageous. The end pipe segments then form the cable lugs mentioned above and provide a mechanically sufficiently firm and stiff structure so that a cable duct with shielding contacting can be assembled and furthermore a temperature-control fluid can control the temperature of the strand by means of a passage. In this instance, the above-mentioned internal insulation or insulation layer (in particular the EPC shielding) preferably additionally performs the function of a fluid seal.

The insulation may where applicable be fixed with an additional pressing element on the relevant pipe segment. Preferably, this pressing element is part of the cable duct, for example, it may be a pressing ring of the shielding.

Another variant involves the end pressing being carried out in such a manner that a recess (an aperture) is introduced into the pipe end which is pressed flat, for example, by means of a punching process which is integrated with the strand during the pressing of the pipe ends, in order to save a working step. Using the recess, a clamping (connection) of the line with an electrical connection can subsequently be carried out, preferably by means of screwing.

With an embodiment for coupling a liquid temperature-control fluid, an additional coupling element (EKE: or coupling/connection element) which contacts the pipe in a fluid-tight manner and represents an interface for fluid supply can be used. This connection element is preferably produced from plastics material in order to provide an electrical insulation between the pipe and fluid supply. Preferably, the production of the connection element is carried out in a multi-component injection-molding operation in order to be able to integrate a sealing element.

The EKE (coupling element) may additionally be configured in such a manner that a snap-fitting function which after assembly can optionally be secured at the rear with an additional component is integrated in order to withstand the fluid pressure during operation and accelerations or mass forces during assembly.

The EKE (coupling element) may additionally take up the function of a contact protection from components which are subjected to voltage.

The following further developments of the power line apparatus according to the invention have been found to be particularly advantageous in practice.

In one embodiment of the power line apparatus according to the invention, the strand has a length which substantially corresponds to a length of the fluid line element.

In this manner, a compact embodiment in which in particular the strand can be secured by means of simply pressing the ends of the fluid line element relative thereto is obtained.

In another embodiment of the power line apparatus according to the invention, at least one end of the fluid line element, preferably both ends, is pressed flat together with the strand (compressed), preferably in the manner of a (press) cable lug, and has extremely preferably an aperture for forming a screw connection to a live component.

This subject and the specific advantages of this embodiment have already been discussed repeatedly above.

In yet another embodiment of the power line apparatus according to the invention, the fluid line element and the strand are additionally connected at the mentioned end or the ends in a materially engaging manner, in particular welded, soldered or adhesively bonded.

In particular, a fluid-tightness in this region can thereby be achieved, which has also already been referred to.

In another embodiment of the power line apparatus according to the invention, at least one of the openings is arranged in a wall of the fluid line element in a transition region, which transition region is arranged between the end which is pressed flat and a non-deformed region of the fluid line element.

In this manner, the opening with the opening face thereof (face which is circumscribed by an edge of the opening) may be orientated obliquely with respect to a longitudinal extent direction of the fluid line element, which in particular can facilitate a blowing-in action or compressed air as the temperature-control medium.

In another embodiment of the power line apparatus according to the invention, at least one of the openings is arranged in a wall of the fluid line element in a non-deformed region of the fluid line element.

This may facilitate an arrangement of the EKE (coupling element) already set out above.

In yet another embodiment of the power line apparatus according to the invention, accordingly on the at least one opening a connection element or EKE is arranged for (fluid-tight) connection of a temperature-control fluid line, preferably in the form of a saddle-like connection piece with an angled coupling portion, which coupling portion preferably extends at least locally parallel with the fluid line element.

For example, a fluid (hose) line for a temperature-control fluid can then be simply pushed onto the coupling portion.

With yet another embodiment of the power line apparatus according to the invention, the fluid line element is at least at one end in the form of a standardized fluid connection piece, in particular a VDA connection piece, wherein an opening of the connection piece forms a relevant opening of the fluid line element.

Consequently, the fluid line element may be readily connected in an axially fluid-guiding manner to an additional fluid line in order to supply or discharge the temperature-control fluid.

In yet another embodiment of the power line apparatus according to the invention, the strand or the strand wires is/are in the region of the fluid connection piece placed against an inner side of the fluid line element, preferably by means of a clamping ring which is introduced into the fluid line element.

Preferably, the power connection is then carried out in this region from the outer side, wherein inside the fluid line element, preferably inside the clamping ring, a passage for the temperature-control fluid remains free.

In yet another embodiment of the power line apparatus according to the invention, between the fluid line element and the strand at least one spacer is arranged, preferably an annular spacer with circumferentially spaced projections.

A safe throughflow of the fluid line element and safe flow around the strand with the temperature-control fluid is thereby ensured.

In another embodiment of the power line apparatus according to the invention, the strand wires are connected to each other in at least one portion, preferably in a materially engaging manner, so that the strand in the portion has a reduced cross section and the fluid-guiding element in the mentioned portion is at a plurality of positions which are spaced apart from each other in a circumferential direction, preferably at least three positions which are spaced apart from each other in a uniform manner, presses against the strand, wherein extremely preferably the fluid-guiding element and strand are additionally connected in a materially engaging manner at the positions mentioned.

In this manner, it can be ensured that a safe throughflow of the fluid-guiding element and a safe flow around the strand with the temperature-control fluid is carried out.

In yet another embodiment of the power line apparatus according to the invention, the strand wires are retained on at least one annular retention element which in an axial position is inserted into the fluid-guiding element and is supported at several locations from the inner side on the fluid-guiding element, which retention element has a central aperture for fluid passage and preferably at the outer side thereof a plurality of receiving members for individual strand wires or bundles of strand wires.

In this manner, it can also be ensured that a safe throughflow of the fluid-guiding element and a safe flow around the strand with the temperature-control fluid is carried out.

In yet another embodiment of the power line apparatus according to the invention, in the fluid line element in one region a resilient element is inserted, which element locally applies a force externally against an inner side of the fluid line element and brings the strand wires into abutment at the inner side.

Additionally or alternatively, a safe throughflow of the fluid-guiding element and a safe flow around the strand with the temperature-control fluid are thereby ensured.

In a further development of this notion, there may still be provision for the resilient element to comprise a shape memory alloy or to be in the form of a braid sleeve made of spring steel, preferably in the manner of a stent or vessel support, as in principle known from medicine.

In order in particular to be able to shield EM radiation which occurs during charging operations, in a preferred embodiment the fluid-guiding element is at least partially, preferably in a portion between the two openings, surrounded by an electromagnetically effective (EMC) shielding, which shielding preferably comprises: a first electrical insulation sheath which is arranged externally on the fluid-guiding element; an EMC shielding layer, in particular made of a metal braid; and a second electrical insulation sheath which is arranged externally on the EMC shielding layer.

Furthermore, there may be provision externally on the fluid-guiding element (specifically on the first insulation sheath) for there to be fitted a cable duct element which contacts the shielding, for example, for connection to a housing or the like.

It has already been mentioned that in a particularly advantageous further development of the power line apparatus according to the invention, the fluid-guiding element is configured to be flexible in at least one portion, in particular corrugated, preferably corrugated in an annular manner or corrugated in a helical manner.

The apparatus can thus also be adapted to narrow structural spaces.

A further development of the method according to the invention makes provision for the introduction of the strand to be carried out in step g) or g′) by laying the strand in the fluid-guiding element when it is produced in step a) and simultaneously cutting to length in step e) or g″) by providing a strand portion with a length which is twice as large as the length of the fluid-guiding element in step e), gripping the strand portion at a gripping location at the center thereof and introducing the strand portion into the fluid-guiding element by means of an open end thereof beginning with the gripping location.

Both approaches avoid the technical difficulty of having to introduce a sufficiently thick strand wire bundle into a long pipeline element.

Another further development of the method according to the invention makes provision for at least one end of the fluid-guiding element to be pressed flat together with the strand, preferably in order to produce a type of (press) cable lug and extremely preferably in the end which has been pressed flat for an aperture to be formed in order to form a screw connection.

The properties and advantages of this construction have already been referred to above. When the pressing and the formation of the aperture is carried out in one working step, process time and complexity can accordingly be saved.

Yet another further development of the method according to the invention makes provision for the fluid line element and the strand to be additionally connected to each other in a materially engaging manner in the region of the end which has been pressed flat, in particular welded, soldered or adhesively bonded.

The properties and advantages of this construction have also already been referred to above. In particular, a fluid-tight closure can thus be achieved.

Yet another further development of the method according to the invention makes provision for a connection element (or EKE) for connecting a temperature-control fluid line to be arranged at least at one of the openings, preferably in the form of a saddle-like connection piece with an angled coupling portion, which coupling portion preferably extends at least locally parallel with the fluid line element.

The properties and advantages of this construction have also already been referred to above. In particular, a fluid-tight connection to an external fluid line system can thus be achieved. Furthermore, the EKE (coupling element) may act in an electrically insulating manner when produced from plastics material.

Finally, yet another further development of the method according to the invention makes provision for the strand wires, in particular before being introduced into the fluid line element, to be connected to each other in at least one portion, preferably in a materially engaging manner, so that the strand in the portion has a reduced cross section, and in which the fluid line element after the strand has been introduced in the portion mentioned, at a plurality of positions which are spaced apart from each other in the circumferential direction, preferably at least at three positions which are spaced apart from each other in a uniform manner, is pressed against the strand, wherein extremely preferably the fluid line element and strand are additionally connected to each other at the positions mentioned in a materially engaging manner.

This embodiment has also already been described in detail above. As a result of the previous connection of the strand wires, it is ensured that, when the line element is locally pressed against the strand, the strand wires do not fan out and become damaged.

In a further development of the method according to the invention for temperature-controlling a power line, there may further be provision for the temperature-control fluid to be introduced (blown) into the fluid line element in the form of (compressed) air or another gas directly through the openings, in particular through at least one opening in the mentioned transition region of the fluid line element, and discharged from the fluid line element.

A specific seal is in this instance in principle not required so that a particularly simple configuration is produced.

In a further development of the method according to the invention for temperature-controlling a power line, there may further be provision for a temperature-control fluid line with an in particular liquid temperature-control fluid, for example, oil, to be connected to the connection element and for the temperature-control fluid to be introduced into the fluid line element or discharged from the fluid line element through the connection element.

The temperature-control power can thus be significantly increased.

In this context, one of the above-mentioned configurations with EKE (coupling element) is preferably used in order to introduce the liquid temperature-control fluid into the fluid line element or to discharge it from the fluid line element.

### BRIEF DESCRIPTION OF THE DRAWINGS

Other properties and advantages of the inventions will be appreciated from the following description of exemplary embodiments with reference to the drawings. In the drawings:

FIG. 1 shows a perspective view of a first embodiment of the power line apparatus according to the invention;

FIG. 2 shows a section through the embodiment in FIG. 1;

FIG. 3 shows a perspective view of a second embodiment of the power line apparatus according to the invention;

FIG. 4 shows a section through the embodiment in FIG. 2;

FIG. 5 shows a layered construction of the power line apparatus according to the invention in detail;

FIGS. 6A-6F show steps of the production method according to the invention;

FIGS. 7 and 8 show the media flow in the embodiment of the power line apparatus according to the invention according to FIG. 1;

FIGS. 9 and 10 show the media flow in the embodiment of the power line apparatus according to the invention according to FIG. 3;

FIGS. 11A and 11B show sectioned views of an alternative embodiment of the power line apparatus according to the invention;

FIGS. 12A and 12B show sectioned views of a first embodiment for locating the strand in a power line apparatus according to the invention;

FIGS. 13A and 13B show sectioned views of a second embodiment for locating the strand in a power line apparatus according to the invention;

FIGS. 14A and 14B show sectioned views of a third embodiment for locating the strand in a power line apparatus according to the invention; and

FIGS. 15A and 15B show sectioned views of a fourth embodiment for locating the strand in a power line apparatus according to the invention.

### DETAILED DESCRIPTION

In the Figures, the same reference numerals refer in each case to elements which are identical or have the same action.

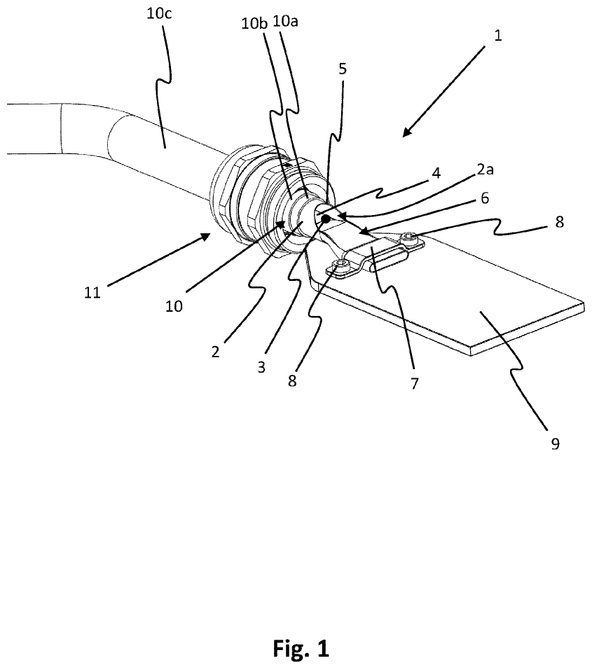

FIG. 1 shows a perspective illustration of an end or a connection region of a temperature-controllable power line apparatus according to the invention which is generally designated 1. It comprises a tubular fluid line element (or simply pipe) 2 made of an electrically conductive material, in particular metal, preferably copper or aluminum, including corresponding alloys, which pipe 2 has at least two openings, of which as a result of the selected illustration only one can be seen at the reference numeral 2a. The openings are preferably arranged at the different ends of the fluid line element 2. Within the fluid line element 2 is a free space 3, which free space 3 provides a fluid-guiding connection between the two openings, that is to say, the opening 2a and the additional opening at the other end of the arrangement.

In the fluid line element 2, a strand 4 with a plurality of strand wires (not illustrated individually), preferably made of copper, is guided, wherein the free space 3 at least in regions along the fluid line element 2 extends around the strand 4, as will be shown below. The strand 4 or the strand wires is/are in the connection region shown and preferably in both connection regions at the ends of the fluid line element 2 placed onto the fluid line element 2, that is to say, preferably pressed onto the (inner) wall thereof, or vice versa.

According to the embodiment in FIG. 1, to this end, at least the shown end of the fluid line element 2 (and preferably also the other end which is not shown) has an incision at reference numeral 5 and is subsequently together with the strand 4 pressed flat at the ends in the manner of a press cable lug 6. The press cable lug 6 is fixed by means of a flap 7 and two screws 8 to a connection plate 9 which is or can be connected to a power source (not shown). As a result of the opening 2a formed by the incision, a temperature-control fluid, preferably (compressed) air, can be introduced into the fluid line element 2 in order to control, in particular cool, the temperature of this and the strand 4. Preferably, the temperature-control fluid is discharged again through a corresponding opening at the other end of the arrangement. At least one of the openings 1 is according to FIG. 1 arranged in a wall of the fluid line element 2 in a transition region, which transition region is arranged between the end which has been pressed flat (the cable lug 6) and a non-deformed region of the fluid line element 2.

The fluid line element 2 and the strand 4 may, in addition to the pressing, additionally be connected to each other in a materially engaging manner at the end shown or at the other end, in particular welded, soldered or adhesively bonded.

FIG. 1 shows still other components of the power line apparatus 1 according to the invention, that is to say, an electromagnetically active EMC shielding 10 which at least partially surrounds the fluid line element 2, preferably in a portion between the two openings, which shielding comprises a first, inner electrical insulation sheath 10a which is arranged externally directly on the fluid line element 2, an EMC shielding layer 10b, in particular made of a metal braiding, which is fitted to the insulation sheath 10a, and a second electrical insulation sheath 10c which is arranged externally on the EMC shielding layer 10b. The reference numeral 11 designates a multi-component cable duct element which can be screwed and which contacts the EMC shielding layer 10b in an electrically conductive manner (not visible in FIG. 1) in order to provide a connection possibility with respect to a housing or the like (not shown in FIG. 1).

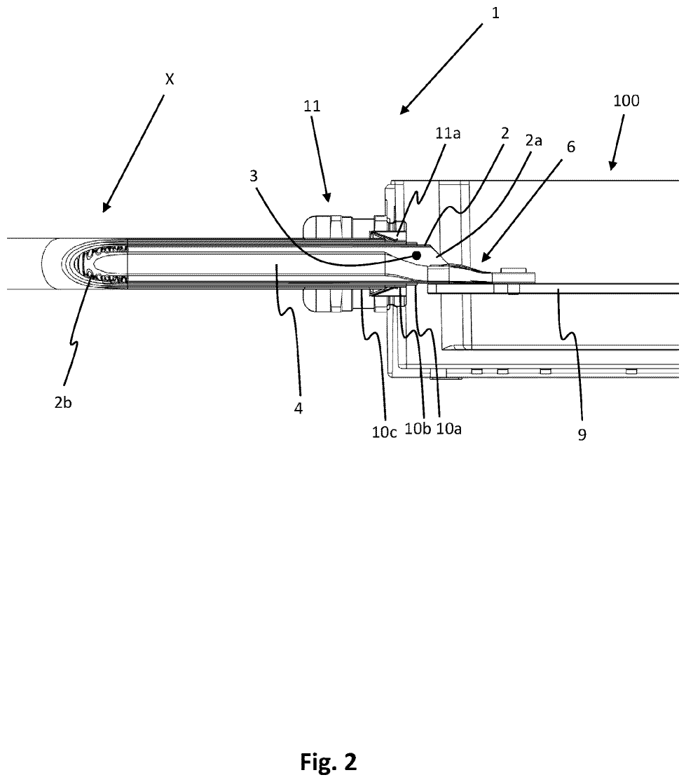

FIG. 2 shows the arrangement of FIG. 1 as a longitudinal section. In this instance, there is also shown the housing 100 which is already mentioned above and through which the power line apparatus 1 is guided. The mentioned multi-component construction of the cable duct element 11 can also be partially seen, specifically a chamfered screwing-in portion 11a which contacts the shielding 10b. The cable duct element 11 per se is not part of the present patent application.

Furthermore, it can be seen in FIG. 2 that the pipe 2 is configured to be bent in a portion (at reference numeral X) and at the same time corrugated with a corrugation 2b in order to achieve corresponding flexibility. The corrugation 2b may be an annular corrugation or a helical corrugation, wherein the latter may be preferred for production reasons.

The strand 4 is guided centrally within the pipe 2, which will be discussed in greater detail below.

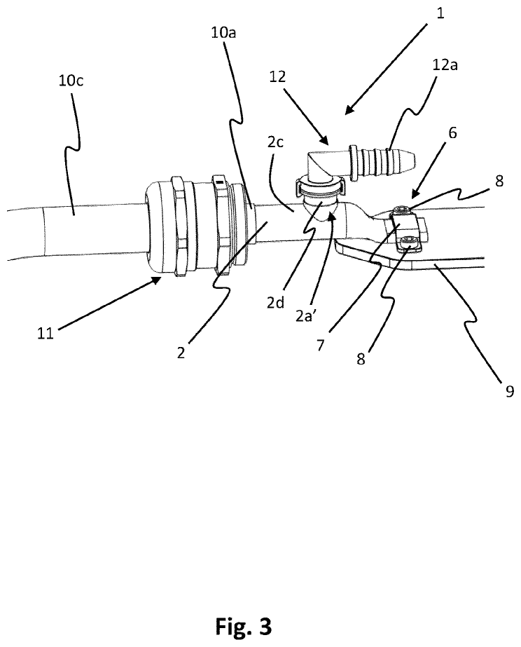

In FIG. 3, a variant of the power line apparatus 1 according to the invention is shown; in this instance, only the significant differences with respect to the embodiment in FIG. 1 are intended to be discussed in greater detail.

According to FIG. 3, the power line apparatus 1 has at least one opening 1 in a wall 2c of the fluid line element 2, which opening is arranged at reference numeral 2a′ in a non-deformed region of the fluid line element 2 and branches off at right-angles to a longitudinal axis of the fluid line element 2. On this opening 2a′ a connection element 12 for connecting a temperature-control fluid line (not shown) is arranged, which connection element 12 has an angled connection portion 12a, which connection portion 12a extends at least in the region shown parallel with the fluid line element 2.

The connection element 12 may in particular be (releasably) secured to an extrusion or a saddle-like connection piece 2d of the fluid line element 2, for example, by means of the snap-fitting mechanism shown with an optional additional securing member. The invention is not limited in this regard.

The strand cannot be seen in FIG. 3 since it is completely surrounded by the pipe 2. The press connection at reference numeral 6 is preferably configured in a fluid-tight manner, to which reference has already been made.

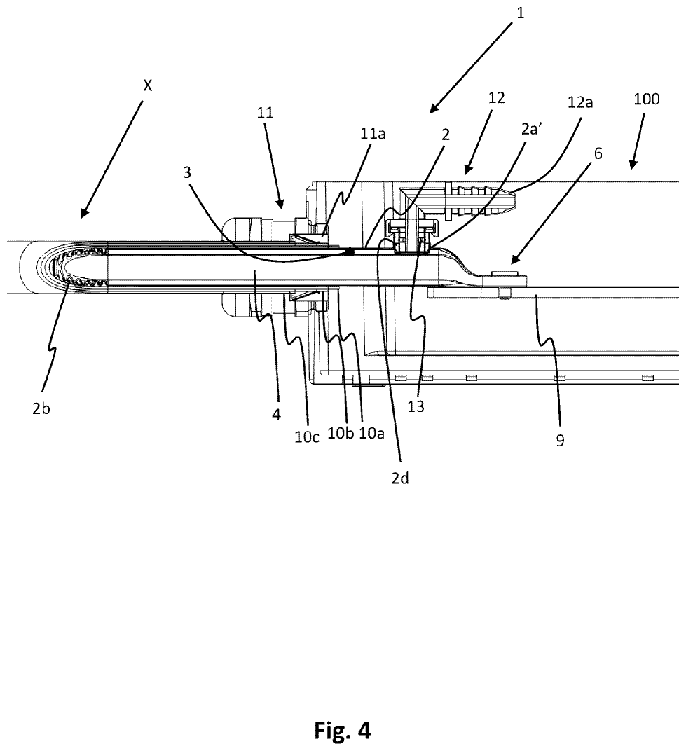

FIG. 4 shows a section similar to FIG. 2 through the arrangement in FIG. 3. It is possible to see in particular in the connection region of the saddle-like connection piece 2d and connection element 12 another seal 13 which may be injection-molded.

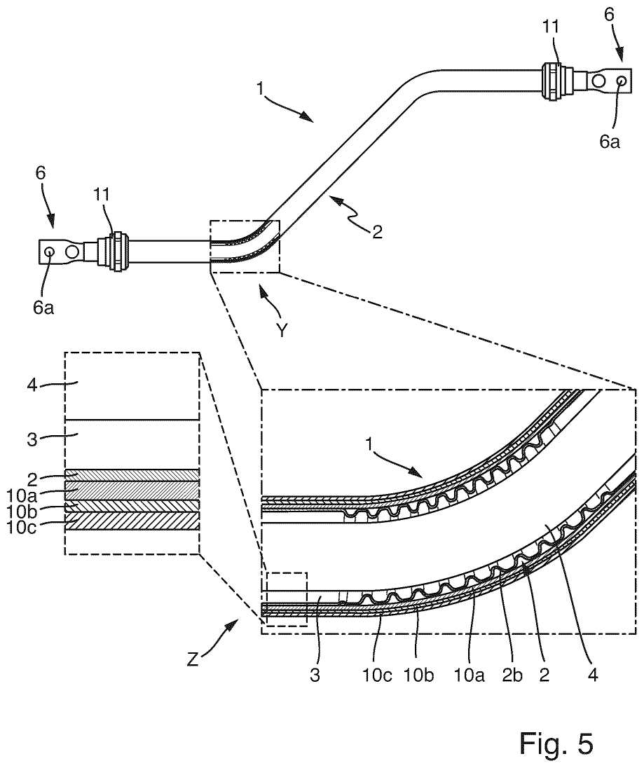

FIG. 5 first shows a complete power line apparatus 1 with two ends which may specifically be configured in an identical manner, in particular according to FIG. 1 as shown. Both ends of the fluid line element 2 are in this instance pressed flat together with the strand 4 in the manner of a (press) cable lug 6 and have an aperture 6a for forming a screw connection with an electrical connection, such as the connection plate 9, cf. FIGS. 1 to 4.

At reference numeral Y a section through the fluid line element 2 and the other components of the power line apparatus 1 is shown in order to illustrate the sequence of the individual layers or components. It is possible to see, from the outer side to the inner side: insulation 10c, shielding 10b, insulation 10a, pipe or fluid line element 2 (partially corrugated, 2b), free space 3 and strand 4. This is illustrated again on a larger scale at reference numeral Z.

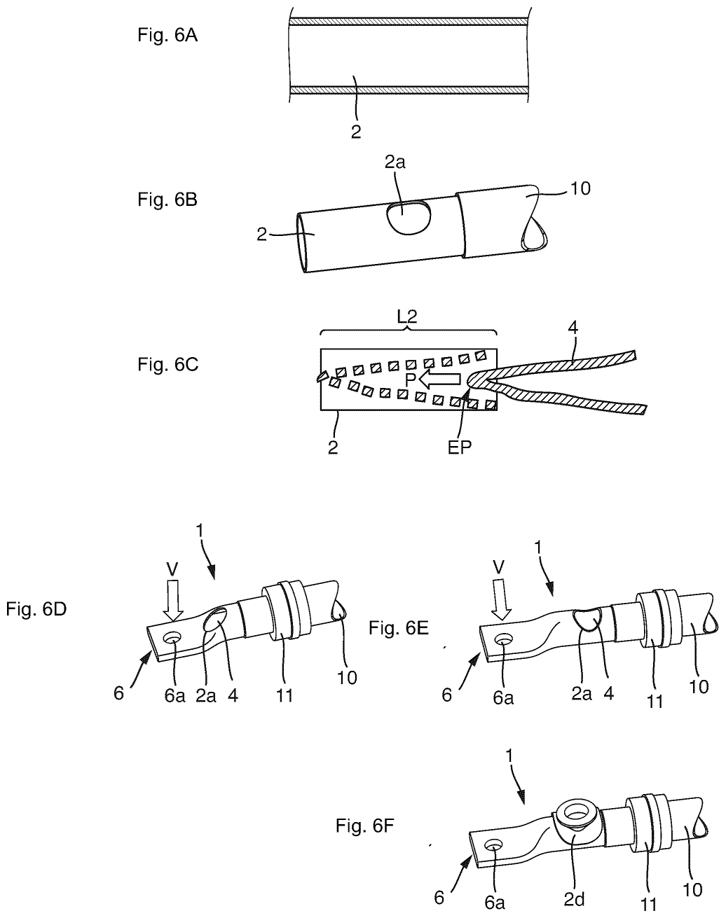

FIGS. 6A-6F show a plurality of steps of a production method according to the invention for the power line apparatus 1.

The method for producing a temperature-controllable power line apparatus 1, cf. FIGS. 1 to 5, comprises:

Step a), shown in FIG. 6A. includes producing a tubular fluid line element 2 from an electrically conductive material, in particular metal, preferably copper or aluminum, including corresponding alloys, in particular by there first being produced by bending or rolling a corresponding metal sheet a hollow member which is then welded at the joints by means of a longitudinal seam.

Subsequently, at least one corrugated portion of the fluid line element 2 can optionally be produced, as shown in FIGS. 2, 4 and 5 (reference numeral 2b), in particular by applying pressure from the outer side (for example, mechanically) or from the inner side (by means of fluid pressure). The pipe 2 is then preferably cleaned.

Then, as can be seen in FIG. 6B, in step b), the EMC shielding 10 (where applicable, with the cable duct element 11, cf. FIGS. 1 to 5) is fitted, in particular as described above. Furthermore, the fluid line element 2 including the EMC shielding 10 is cut to a desired length L2, cf. FIG. 6C, step c). Furthermore, it is shown in FIG. 6B, step b) that an opening 2a has been produced in the fluid line element 2, which opening 2a is arranged at an end of the fluid line element 2 by an aperture in a wall 2c of the fluid line element 2 being produced by means of punching. Depending on the desired configuration (cf. FIGS. 1 and 2 or 3 and 4), a distance of the aperture from the end of the fluid line element 2 is selected in an appropriate manner.

In step c), shown in FIG. 6C, a strand 4 having a plurality of strand wires, preferably made of copper, the length of which corresponds to a desired length L2 of the power line apparatus 1, is introduced into the fluid line element 2.

This is preferably carried out in that the method provides for a strand portion having a length which is twice as great as the length L2 of the power line apparatus 1 or the fluid line element 2. The strand portion at a gripping point EP is then gripped at the center thereof using a suitable tool (not shown) and pulled into the fluid line element 2 through an open end thereof beginning with the gripping point EP (arrow P).

Alternatively, the strand 4 can be placed into the fluid line element 2 when it is produced in step a) and cut to length together therewith.

In step d), shown in FIG. 6D, (cf. FIGS. 1 and 2) or step e), shown in FIG. 6E, (cf. FIGS. 3 and 4), the pipe end and strand 4 are pressed in the manner of a cable lug 6, as described above (arrow V); preferably, in the same working step, the aperture 6a (cf. FIG. 5) is also formed for producing a screw connection to an electrical connection.

Following step e), in step f), shown in FIG. 6F, the saddle-like connection piece 2d according to FIGS. 3 and 4, which may in particular comprise a plastics material is fitted.

In this instance, in step d), during pressing the strand 4 or the strand wires are pressed in the respective connection region onto the fluid line element 2, preferably in each case in a connection region at each end of the fluid line element 2.

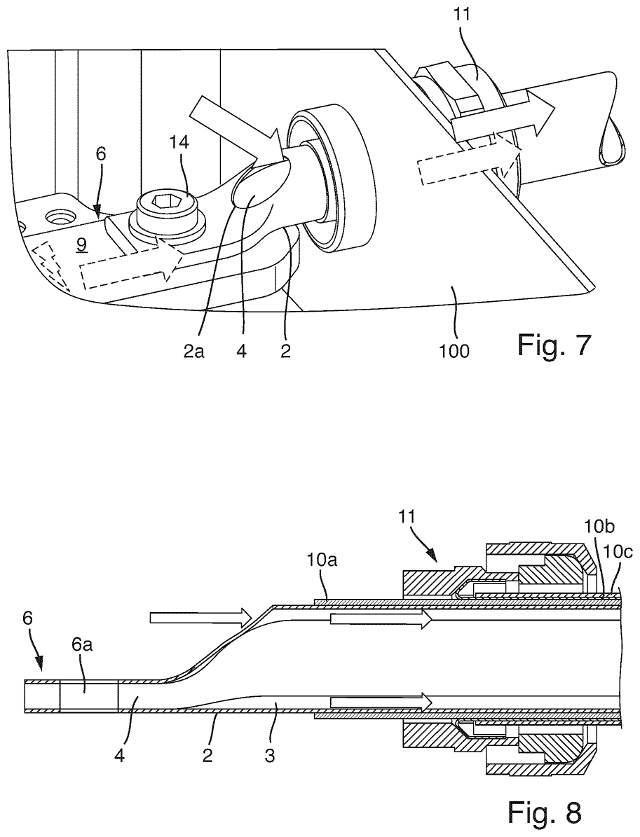

FIG. 7 shows the power line apparatus according to FIG. 6d) after connection to a housing 100 (via the cable duct element 11) and screw connection at the reference numeral 14 (via the aperture 6a) to the connection plate 9.

The dashed arrows depict the current flow (via the connection plate 9, cable lug 6, strand 4 and pipe 2), whilst the solid arrows indicate the flow of the temperature-control fluid (in this instance, preferably compressed air) (through the opening 2a into/through the free space 3 (cf. FIG. 5) inside the pipe 2).

FIG. 8 shows the associated longitudinally sectioned view (without a housing, screw and connection plate). The details of the cable duct element 11 will not be further discussed here.

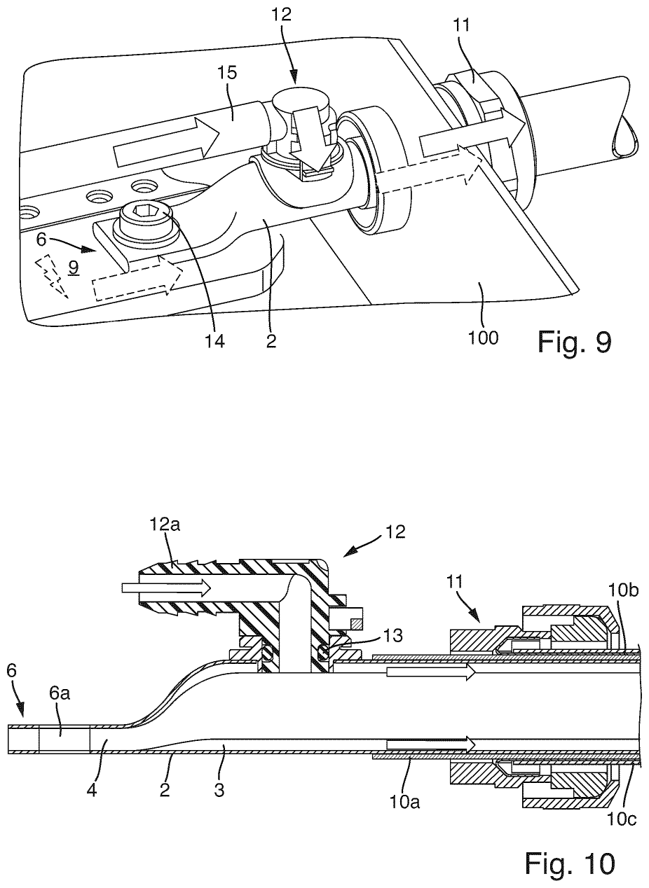

FIG. 9 shows the power line apparatus according to FIG. 6f) after connection to a housing 100 (via the cable duct element 11) and screw connection at the reference numeral 14 (via the aperture 6a) to the connection plate 9. Furthermore, the connection element 12 has been connected via the connection portion 12a (cf. FIGS. 3 and 4) to a temperature-control fluid line 15.

The dashed arrows again depict the current flow (via the connection plate 9, cable lug 6, strand (not visible) and pipe 2) whilst the solid arrows indicate the flow of the temperature-control fluid (in this instance, preferably a dielectric oil) (via the connection element 12 through the inside of the pipe 2).

FIG. 10 shows the associated longitudinally sectioned view (without any housing, screw and connection plate). The details of the cable duct element 11 are also not intended to be discussed further here.

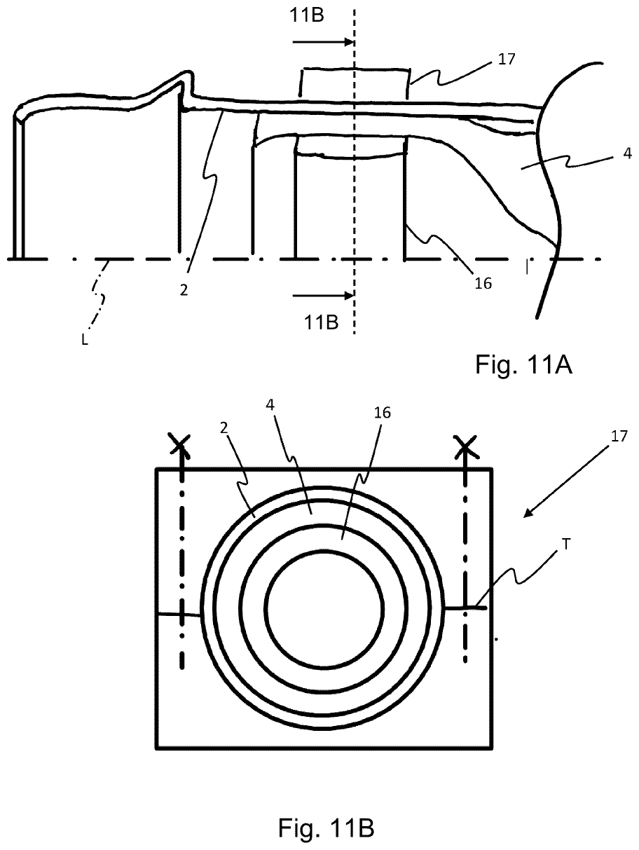

FIGS. 11A and 11B show an alternative embodiment of the power line apparatus 1 at (a) connection end, shown in FIG. 11A as a longitudinal section, and in FIG. 11B as a cross section along the line 11B-11B in FIG. 11A.

The pipe 2 is configured at the end shown in the manner of a fluid connection piece, specifically of the VDA type. The strand 4 is slightly shorter than the pipe 2 and placed by means of an internal clamping ring 16 or the like from the inner side against the pipe 2 (pressed; either at one side or fanned open circumferentially). L denotes to the longitudinal axis. At the outer side in the region of the clamping ring 16 there is arranged an electrical connection portion 17 which can be separated at reference numeral T into two halves and which at the same time can be configured to retain the pipe 2. The connection for the temperature-control fluid is then simply fitted or pushed onto the free end of the pipe 2 (top left in FIG. 11A). Consequently, the opening of the connection piece (top left in FIG. 11A) forms a relevant opening of the fluid line element 2.

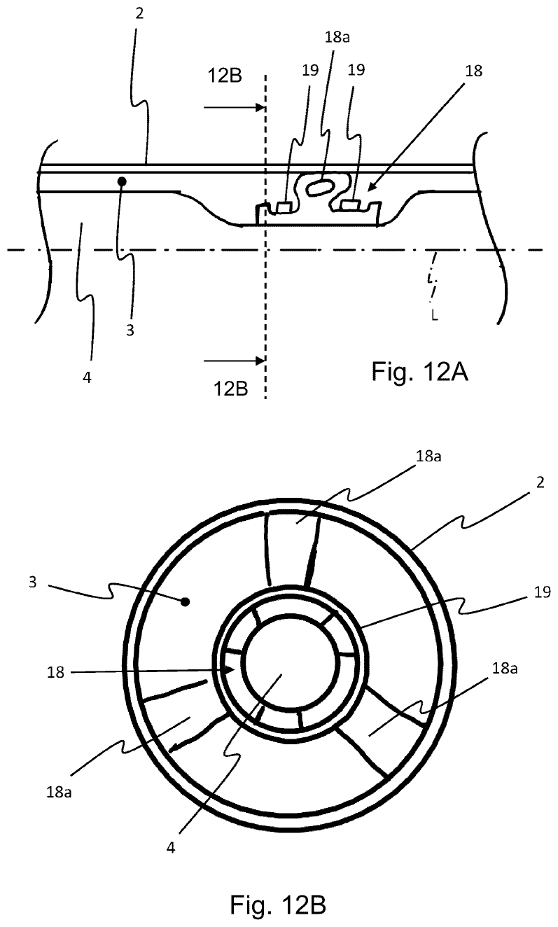

FIGS. 12A and 12B show a possibility for guiding the strand 4 inside the pipe 2, shown in FIG. 12A in the longitudinal section, and in FIG. 12B in cross section taken along line 12B-12B in FIG. 12A.

Between the fluid line element (pipe) 2 and the strand 4 there is arranged at least one spacer 18 which is in the form of an annular spacer 18 having (in this instance, without limitation, three) circumferentially spaced-apart projections 18a, which projections 18a interact from the inner side with the pipe 2. The spacer 18 is retained by means of cable ties 19 or the like on the strand 4 and reduces the cross section thereof, wherein the strand 4 is fixed on the center of the arrangement along the longitudinal axis L. Between the projections 18a, the temperature-control fluid can flow in an unimpeded manner.

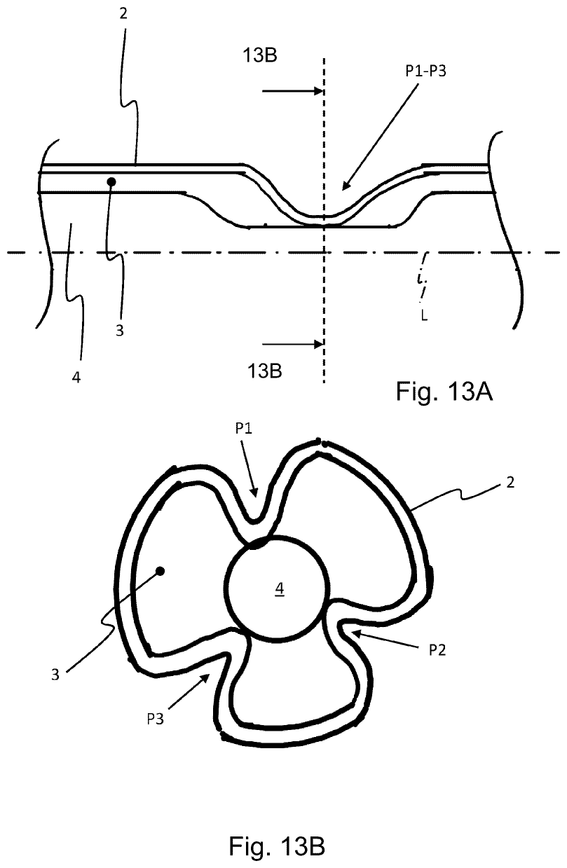

FIGS. 13A and 13B show another possibility of guiding the strand 4 inside the pipe 2, shown in FIG. 13A in cross section, and in FIG. 13B in cross section taken along the line 13B-13B in FIG. 13A.

In the power line apparatus 1 shown, the strand wires are connected to each other in at least one portion, preferably in a materially engaging manner, for example, by means of ultrasonic welding, so that the strand 4 in the portion has a reduced cross section, cf. the cutting plane 13B-13B. The fluid line element 2 is in the portion mentioned pressed against the strand 4 at a plurality of positions P1-P3 which are spaced apart from each other in a circumferential direction, preferably at least three positions P1-P3 which are spaced apart from each other in a uniform manner, wherein extremely preferably the fluid line element 2 and strand 4 at the mentioned positions P1-P3 are additionally connected to each other in a materially engaging manner.

Also in the embodiment according to FIGS. 12A and 12B, it is advantageous for the strand wires of the strand 4 to be connected to each other before the spacer 18 is fitted in the relevant portion, preferably in a materially engaging manner, for example, by means of ultrasonic welding, so that the strand 4 has a reduced cross section in the portion.

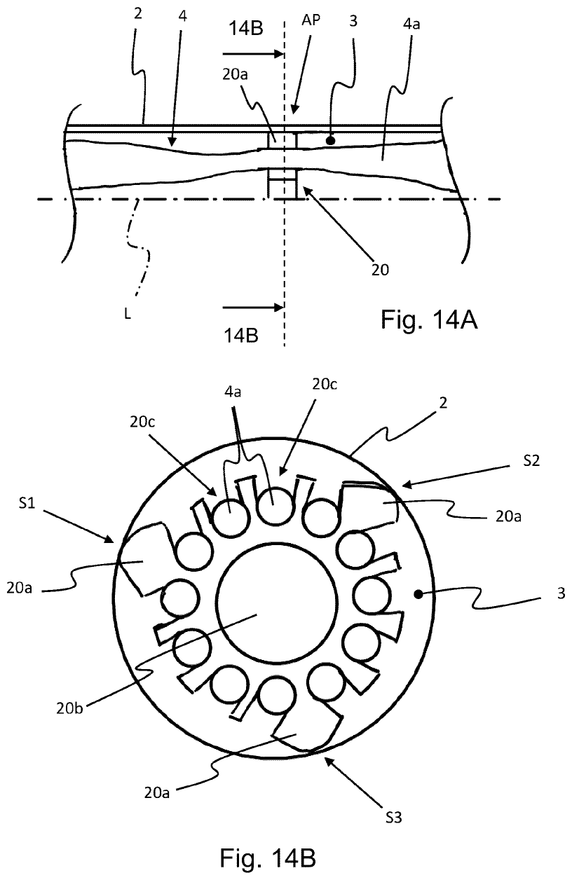

FIGS. 14A and 14B show yet another possibility for guiding the strand 4 inside the pipe 2, shown in FIG. 14A in cross section, and in FIG. 14B in cross section along the line 14B-14B in FIG. 14A.

In the power line apparatus shown, the individual strand wires (or bundles of strand wires) 4a are retained on at least one annular retention element 20 which in an axial position AP is inserted into the fluid line element 2 and is supported at a plurality of locations S1-S3 which are distributed over the circumference with corresponding projections 20a from the inner side on the fluid line element 2. The retention element 20 is preferably made from a resilient plastics material and has a central aperture 20b for fluid passage. It has at the outer side thereof a plurality of receiving members or recesses 20c (only partially illustrated) for individual strand wires (or strand wire bundles) 4a in order to fix them in position.

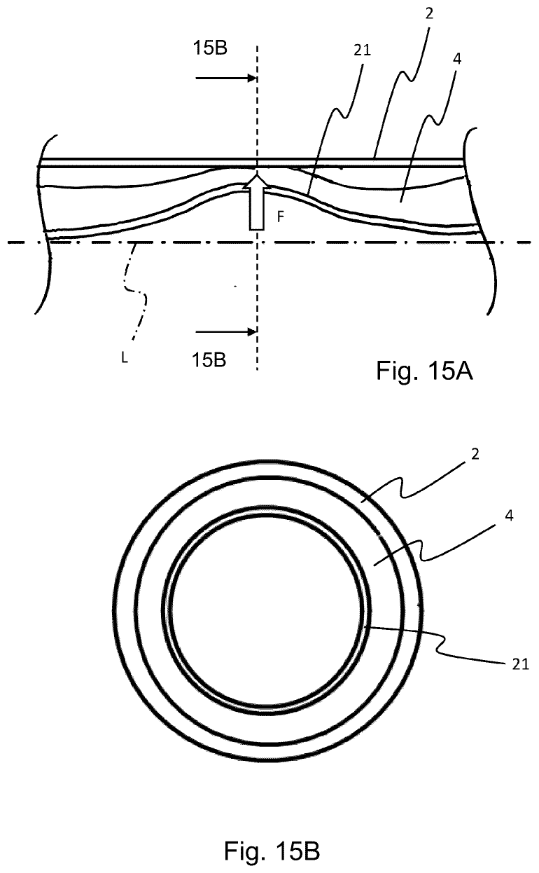

FIGS. 15A and 15B finally show yet another possibility for guiding the strand 4 inside the pipe 2, shown in FIG. 15A in cross section, and in FIG. 15B in cross section along the line 15B-15B in FIG. 15A.

In the power line apparatus shown, in the fluid line element 2 at least in a region a sleeve-like resilient element 21 is inserted, which element 21 locally applies a force F externally against an inner side of the fluid line element 2 and thus brings the strand 4 or the individual strand wires (or bundles of strand wires) into abutment with the inner side of the fluid line element 2. The resilient element 21 preferably comprises a shape memory alloy or is in the form of a braided sleeve made of spring steel, preferably in the manner of a stent, as known in principle from medical technology.

In principle, the embodiments according to FIG. 12Aff can be used in all power line apparatuses 1 according to FIGS. 1 to 11, where applicable also in combination.

1. A temperature-controllable power line apparatus (1), comprising:
a tubular fluid line element (2) made of an electrically conductive material;
at least two openings (2a, 2a′) of the fluid line element (2), said openings (2a, 2a′) are arranged at different ends of the fluid line element (2); and
a free space (3) inside the fluid line element (2), the free space (3) provides a fluid-guiding connection between the two openings (2a, 2a′),
a strand (4) guided in the fluid line element (2), the strand (4) having a plurality of strand wires; and
the free space (3) extends at least in regions along the fluid line element (2) around the strand (4); and at least one of the strand (4) or the strand wires in at least one connection region is/are placed on the fluid line element (2), or the fluid line element (2) in at least one connection region is placed on at least one of the strand (4) or the strand wires.

2. The power line apparatus (1) as claimed in claim 1, wherein the strand (4) has a length which corresponds to a length (L2) of the fluid line element (2).

3. The power line apparatus as claimed in claim 1, wherein at least one of the ends of the fluid line element (2) is pressed flat together with the strand (4).

4. The power line apparatus (1) as claimed in claim 3, wherein the fluid line element (2) and the strand (4) are additionally connected at the at least one of the ends in a materially engaging manner, via a welded, a soldered or an adhesively bonded connection.

5. The power line apparatus (1) as claimed in claim 3, wherein at least one of the openings (2a, 2a′) is arranged in a wall (2c) of the fluid line element (2) in a transition region, and the transition region is arranged between the end which is pressed flat and a non-deformed region of the fluid line element (2).

6. The power line apparatus (1) as claimed in claim 1, wherein at least one of the openings (2a, 2a′) is arranged in a wall (2c) of the fluid line element (2) in a non-deformed region of the fluid line element (2).

7. The power line apparatus (1) as claimed in claim 6, further comprising a connection element (12) for connecting a temperature-control fluid line (15), the connection element (12) is arranged on the at least one opening (2a, 2a′), and the connection element (12) includes a saddle-shaped connection piece (2d) having an angled connection portion (12a), and the connection portion (12a) extends parallel with the fluid line element (2).

8. The power line apparatus (1) as claimed in claim 1, wherein the fluid line element (2) at least at one of the ends includes a standardized fluid connection piece, and an opening of the connection piece forms a respective one of the openings of the fluid line element (2).

9. The power line apparatus (1) as claimed in claim 8, wherein the strand (4) or the strand wires are placed in a region of the fluid connection piece on an inner side of the fluid line element, via a clamping ring (16) which is introduced into the fluid line element.

10. The power line apparatus (1) as claimed in claim 9, further comprising at least one spacer (18) arranged between the fluid line element (2) and the strand (4).

11. The power line apparatus (1) as claimed in claim 1, wherein the strand wires are connected to each other in at least one portion so that the strand (4) has a reduced cross section in the at least one portion and in which the fluid line element (2) in the portion mentioned is pressed against the strand (4) at a plurality of positions (P1-P3) which are spaced apart from each other in a circumferential direction.

12. The power line apparatus (1) as claimed claim 1, further comprising at least one annular retention element (20) which is inserted into the fluid line element (2), the strand wires (4a) are retained on the at least one annular retention element (20) in an axial position (AP) and supported at a plurality of locations (S1-S3) from an inner side on the fluid line element (2), and the retention element (20) has a central aperture (20b) for fluid passage and at an outer side thereof a plurality of receiving members (20c) for individual strand wires (4a).

13. The power line apparatus (1) as claimed in one of claim 1, further comprising a resilient element (21) inserted in the fluid line element (2) in a region thereof, the resilient element (21) locally applies a force (F) externally against an inner side of the fluid line element (2) and brings the strand wires into abutment with the inner side.

14. The power line apparatus (1) as claimed in claim 13, wherein the resilient element (21) comprises a shape memory alloy or comprises a braided sleeve made of spring steel.

15. The power line apparatus (1) as claimed in claim 1, wherein the fluid line element (2) is at least partially surrounded by an electromagnetically effective EMC shielding (10), said shielding (10) comprises: a first electrical insulation sheath (10a) which is arranged externally on the fluid line element (2); an EMC shielding layer (10b); and a second electrical insulation shielding (10c) which is arranged externally on the EMC shielding layer (10b).

16. The power line apparatus (1) as claimed in claim 1, wherein the fluid line element (2) is configured to be flexible at least in a portion thereof.

17. A method for producing a temperature-controllable power line apparatus (1), the method comprising:
a) producing a tubular fluid line element (2) from an electrically conductive material;
b) optionally forming at least one corrugated portion of the fluid line element (2);
c) optionally cleaning the fluid line element (2);
d) optionally fitting an EMC shielding (10) on the fluid line element;
e) cutting the fluid line element including the optional EMC shielding if present to a desired length (L2);
f) providing at least two openings (2a, 2a′) in the fluid line element (2), the openings (2a, 2a′) being arranged at different ends of the fluid line element (2);
g) introducing a strand (4) with a plurality of strand wires, a length of which corresponds to the desired length in step e), in the fluid line element (2); and
h) placing at least one of the strand (4) or the strand wires in at least one connection region on the fluid line element (2), or placing the fluid line element (2) on the at least one of the strand (4) or the strand wires in the at least one connection region.

18. The method as claimed in claim 17, wherein the introducing of the strand (4) in step g) is carried out either
g′) by laying the strand (4) in the fluid-guiding element when it is produced in step a) and simultaneously cutting to length in step e) or
g″) by providing a strand portion with a length which is twice as great as the length (L2) of the fluid line element (2) in step e), gripping the strand portion at a gripping location (EP) in the center thereof and introducing the strand portion into the fluid-guiding element (2) by an open end thereof beginning with the gripping location (EP).

19. The method as claimed in claim 17, further comprising pressing at least one end of the fluid-guiding element (2) flat together with the strand (4) to produce a type of cable lug (6).

20. The method as claimed in claim 19, further comprising additionally connecting the fluid line element (2) and the strand (4) to each other in a materially engaging manner in a region of the end which has been pressed flat by welding, soldering or adhesively bonding.

21. The method as claimed in claim 17, further comprising arranging a connection element (12) in at least one of the openings (2a, 2a′) for connecting a temperature-control fluid line (15), the connection element (12) including a saddle-shaped connection piece (2d) having an angled connection portion (12a), and the connection portion (12a) extends parallel with the fluid line element (2).

22. The method as claimed in claim 17, further comprising connecting the strand wires to each other in at least one portion so that the strand (4) has in the portion a reduced cross section, and pressing the fluid line element (2), after the strand (4) has been introduced in the mentioned portion at a plurality of positions (P1-P3) which are spaced apart from each other in a circumferential direction, against the strand (4).

23. A method for temperature-controlling a power line, the method comprising:
a) providing a power line apparatus (1) as claimed in claim 1;
b) electrically contacting the power line apparatus (1) in the connection region;
c) directing a temperature-control fluid through the fluid line element (2) via the openings (2a, 2a′).

24. The method as claimed in claim 23, wherein the temperature-control fluid is introduced into the fluid line element (2) as air or another gas directly through at least one of the openings (2a, 2a′).

25. The method as claimed in claim 23, further comprising connecting a temperature-control fluid line (15) to a connection element (12) arranged on the at least one opening (2a, 2a′), and the temperature-control fluid is introduced through the connection element (12) into the fluid line element (2) or discharged from the fluid line element (2).
